(19) United States
(12) Patent Application Publication
(10) Pub. No.: US 2026/0247167 A1
(43) Pub. Date: Aug. 20, 2026

(54) SYSTEM AND METHOD FOR RECURRENCE COVERAGE HOLE DETECTION IN A NETWORK

(71) Applicant: JIO PLATFORMS LIMITED, Ahmedabad (IN)

(72) Inventors: Aayush BHATNAGAR, Navi Mumbai (IN); Hanumant KADAM, Mumbai (IN); Atul VERMA, Jhansi (IN); Manoj SHETTY, Mumbai (IN); Dharmesh A CHITALIYA, Thane (IN); Sneha VIRKAR, Mumbai (IN); Pradeep Kumar BHATNAGAR, Navi Mumbai (IN)

(73) Assignee: JIO PLATFORMS LIMITED, Ahmedabad (IN)

(21) Appl. No.: 18/992,889

(22) PCT Filed: May 20, 2024
(86) PCT No.: PCT/IN2024/050587

§ 371 Date: Jan. 9, 2025

(30) Foreign Application Priority Data
Jun. 27, 2023 (IN) 202321043155

(51) Int. Cl. H04W 24/02; H04W 24/08

(52) U.S. Cl. CPC H04W 24/02; H04W 24/08

(57) ABSTRACT

The present disclosure provides a system (108) and a method for coverage hole detection in a network. The system (108) receives a data associated with the one or more computing devices from a server. The data includes value corresponding to radio frequency (RF) parameter from various users. The system (108) visualizes polygon boundaries associated with the data within a predefined grid. Further, the system (108) bifurcates the polygon boundaries into a parent polygon and a child polygon based on an area of intersection between the parent polygon and the child polygon.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to systems and methods for optimal performance in a wireless telecommunications network. More particularly, the present disclosure relates to a system and a method for coverage hole in a network.

### DEFINITION

As used in the present disclosure, the following terms are generally intended to have the meaning as set forth below, except to the extent that the context in which they are used to indicate otherwise.

The expression ‘plurality of data samples’ used hereinafter in the specification refers to a data samples that transmits by a user device towards a network node. In an aspect, the data sample includes information regarding the various radio frequency (RF) parameters. Data samples related to RF parameters encompass various aspects such as frequency, bandwidth, power levels, modulation, noise figure, spectrum analysis, propagation characteristics, and bit error rate. Data samples provides insights into the operation, performance, and characteristics of a network, aiding in tasks such as signal analysis, troubleshooting, and system optimization.

The expression ‘predetermined old coverage hole polygon’ used hereinafter in the specification refers to a coverage hole polygon that is determined during a first iteration of detecting the coverage hole. The process of detecting a coverage hole polygon is performed in a plurality of iterations. In an aspect of the specification, during the second iteration of detecting the coverage hole, the coverage hole polygon of the previous iteration is considered as the predetermined old coverage hole polygon. During the second iteration, the recently detected coverage hole is known as a new coverage hole polygon. To differentiate and manage the detected coverage hole polygons, a unique ID is assigned to each one. The ID assigned to the old coverage hole polygon is known as the parent ID, and the ID assigned to the new coverage hole polygon is known as the child ID. If a coverage-challenged area is split during the next generation cycle, the original area is marked as a parent polygon (old coverage hole polygon), and the split area is marked as a child polygon (new coverage hole polygon).

The expression ‘coverage hole’ used hereinafter in the specification refers to an area or zone within a wireless communication network where the signal strength or quality is significantly lower or completely absent. Identifying coverage holes is crucial to ensure seamless connectivity and optimal network performance.

These definitions are in addition to those expressed in the art.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Several coverage challenges need to be addressed in a wireless telecommunications network. The signal strength of a wireless network decreases as it travels through various materials such as walls, ceilings, and floors. This may result in areas with poor signal coverage or even complete dead zones. Further, wireless signals may reflect off surfaces and create multipath interferences, which may result in signal distortion, signal cancellation, and reduced coverage. High-density environments such as large buildings or crowded public areas may strain network capacity and lead to congestion, resulting in reduced coverage and slower speeds. Limited budgets may limit the number and placement of sites, resulting in areas with poor coverage.

There is, therefore, a need in the art to provide a system and a method that can mitigate the problems associated with the prior arts.

### OBJECTS OF THE INVENTION

It is an object of the present disclosure to provide a system and a method that provides early detection by actively monitoring and tracking problems. This allows for timely intervention and prevents the problem from becoming more complex or causing further damage.

It is an object of the present disclosure to provide a system and a method that provides proactive problem-solving by recognizing recurring problems or patterns, develops preventive measures, improves processes, and implements corrective actions to avoid future occurrences.

It is an object of the present disclosure to provide a system and a method that provides efficient resource allocation by tracking and categorizing problems, allocates resources more efficiently, and focuses on high-priority problems.

It is an object of the present disclosure to provide a system and a method that provides continuous improvement via identification tracking and provides valuable data and metrics for analysis.

It is an object of the present disclosure to provide a system and a method that identifies trends, root causes, and underlying systemic issues, thereby improving performance, productivity, and quality.

### SUMMARY

The present disclosure discloses a system for detecting recurrence of coverage holes in a network by analysing coverage hole polygons. The system includes a server and a processing unit. The server is configured to receive a plurality of data samples from a plurality of user equipments residing in a geographic area defined by a plurality of grids. The server is further configured to store a set of plurality of predetermined old coverage hole polygons covering the plurality of grids. The processing unit is configured to cooperate with the server to receive the plurality of data samples and is further configured to aggregate the plurality of data samples corresponding to at least one radio-frequency (RF) parameter to generate a value. The processing unit is configured to identify a plurality of points based on the generated value corresponding to the at least one radio-frequency (RF) parameter. The processing unit is configured to generate a plurality of new coverage hole polygons by using the plurality of identified points. The processing unit is configured to determine an intersection of each of new coverage hole polygon with a predetermined old coverage hole polygon covering a grid. The processing unit is configured to detect the recurrence of the coverage holes by analyzing the determined intersection of the new coverage hole polygon with the predetermined coverage hole polygon.

In an embodiment, the processing unit is further configured to calculate an overlapping area between the new coverage hole polygon and the predetermined old coverage hole polygon and based on the determined overlapping area assigning an ID to each of the plurality of new coverage hole polygons.

In an embodiment, the processing unit is further configured to assign an old parent ID corresponding to the predetermined old coverage hole polygon to the new coverage hole polygon if the overlapping area is greater than or equal to a predetermined value.

In an embodiment, the processing unit is further configured to assign a new child ID to the new coverage hole polygon if the overlapping area is less than the predetermined value.

In an embodiment, the predetermined value is 70%.

In an embodiment, the processing unit is configured to assign a new parent ID to the new coverage hole polygon if the new coverage hole polygon does not intersect with the predetermined old coverage hole polygon or the overlapping area between the new coverage hole polygon and the predetermined old coverage hole polygon is less than 30%.

In an embodiment, the processing unit is configured to generate the new coverage hole polygon by following steps: converting each of the plurality of identified points into the polar coordinates, sorting the plurality of polar coordinates either in a counterclockwise direction or a clockwise direction based on an angle with respect to a centroid for generating an array of sorted polar coordinates, taking a first polar coordinate from the sorted polar coordinates as a starting polar coordinate, choosing a second polar coordinate from the array of sorted polar coordinates, determining a distance between the second polar coordinate and the first polar coordinate, connecting the second polar coordinate to the new coverage hole polygon if the determined distance is lesser than a predefined distance, and removing the connected first polar coordinate and second polar coordinate from the number of polar coordinates.

In an embodiment, the processing unit is further configured to choose a new polar coordinate lies before to the second polar coordinate if the determined distance is greater than the predefined distance and considers the new chosen polar coordinate as the second polar coordinate.

In an embodiment, the at least one RF parameter includes reference signal received power (RSRP), reference signal received quality (RSRQ), received signal strength indicator (RSSI), signal to interference noise ratio (SINR), channel quality index (CQI), physical cell identity (PCI), block error ratio (BLER), downlink throughput, and uplink throughput.

In an embodiment, the predefined distance is 150 meters.

In an embodiment, the second polar coordinate is the right most coordinate from the array of sorted polar coordinates with respect to the first polar coordinate.

In an embodiment, the system is configured to display the generated plurality of new coverage hole polygons and the intersection between the new coverage hole polygon coverage hole and the predetermined old coverage hole polygons on a mapping application.

In an embodiment, the plurality of user equipments includes an indoor user equipment, and an outdoor user equipment.

The present disclosure discloses a method of detecting recurrence of coverage holes in a network by analysing coverage hole polygons. The method includes receiving a plurality of data samples from a plurality of user equipments residing in a geographic area defined by a plurality of grids. The method includes storing a set of plurality of predetermined old coverage hole polygons covering the plurality of grids. The method includes aggregating the plurality of data samples corresponding at least one radio-frequency (RF) parameter to generate a value. The method includes identifying a plurality of points based on the generated value corresponding to the at least one RF parameter. The method includes generating a plurality of new coverage hole polygons by using the plurality of identified points. The method includes determining an intersection of each of new coverage hole polygon with a predetermined coverage hole polygon covering a grid. The method includes detecting recurrence of the coverage holes by analysing the determined intersection of the new coverage hole polygon with the predetermined coverage hole polygon.

In an embodiment, the step of detecting recurrence includes calculating an overlapping area between the new coverage hole polygon and the predetermined coverage hole polygon and based on the determined overlapping area assigning a unique ID to each of the plurality of new coverage hole polygons.

In an embodiment, the method further includes a step of assigning an old polygon ID corresponding to the predetermined coverage hole polygon to the new coverage hole polygon if the overlapping area is greater than or equal to a predetermined value.

In an embodiment, the method further includes a step assigning a new child ID to the new coverage hole polygon if the overlapping area is less than the predetermined value.

In an embodiment, the predetermined value is 70%.

In an embodiment, the method further includes a step assigning a new parent ID to the new coverage hole polygon if the new coverage hole polygon does not intersect with the predetermined old coverage hole polygon or the area of intersection between the new coverage hole polygon and the predetermined old coverage hole polygon is less than 30%.

In an embodiment, the step of generating the plurality of new coverage hole polygons includes converting each of the identified points into the polar coordinates, sorting each of the converted polar coordinates either in a counterclockwise direction or in a clockwise direction based on an angle with respect to a centroid for generating an array of sorted polar coordinates, taking a first polar coordinate from the sorted polar coordinates as a starting polar coordinate, choosing a second polar coordinate from the array of sorted polar coordinates with respect to the first polar coordinate, determining a distance between the second polar coordinate and the first polar coordinate, connecting the second polar coordinate to the new coverage hole polygon if the distance is lesser than a predefined distance, and removing the connected first polar coordinate and second polar coordinate from the number of polar coordinates.

In an embodiment, the method further includes a step of choosing a new polar coordinate lies before to the second polar coordinate if the determined distance is greater than the predefined distance and considering the new chosen polar coordinate as the second polar coordinate.

In an embodiment, the at least one RF parameter includes reference signal received power (RSRP), reference signal received quality (RSRQ), received signal strength indicator (RSSI), signal to interference noise ratio (SINR), channel quality index (CQI), physical cell identity (PCI), block error ratio (BLER), downlink throughput, and uplink throughput.

In an embodiment, the predefined distance is 150 meters.

In an embodiment, the method further includes a step of displaying the generated plurality of new coverage hole polygons and the intersection between the new coverage hole polygon and the predetermined old coverage hole polygon on a mapping application.

In an exemplary embodiment, the present disclosure discloses a user equipment which is configured to detect a plurality of coverage holes in a network. The user equipment includes a processor, and a computer readable storage medium storing programming instructions for execution by the processor. The processor is configured to receive a plurality of data samples from a plurality of user equipments residing in a geographic area defined by a plurality of grids. The processor is configured to store a set of plurality of predetermined old coverage hole polygons covering the plurality of grids. Under the programming instructions, the processor is configured to aggregate the plurality of data samples corresponding at least one radio-frequency (RF) parameter to generate a value. The processor is configured to identify a plurality of points based on the generated value corresponding to each RF parameter. Under the programming instructions, the processor is configured to generate a plurality of new coverage hole polygons by using the plurality of identified points. The processor is configured to determine an intersection of each of new coverage hole polygon with a predetermined old coverage hole polygon covering a grid. The processor is configured to detect recurrence of the coverage holes by analysing the determined intersection of the new coverage hole polygon with the predetermined coverage hole polygon.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture for implementing a system for detecting recurrence of coverage holes in a network by analysing coverage hole polygons, in accordance with an embodiment of the present disclosure.

FIG. 2A illustrates an example block diagram of the system, in accordance with an embodiment of the present disclosure.

FIG. 2B illustrates steps of a method of detecting a recurrence of coverage holes in a network by analysing coverage hole polygons, in accordance with an embodiment of the present disclosure.

FIG. 3 illustrates an example flow diagram for creating a plurality of cover hole polygons, in accordance with an embodiment of the present disclosure.

FIGS. 4A-4C illustrate various exemplary representations of parent-child polygon generation, in accordance with embodiments of the present disclosure.

FIG. 5 illustrates an example flow diagram of assigning polygon ID to a new coverage hole polygon based on parent-child identification (ID) relationship, in accordance with an embodiment of the present disclosure.

FIG. 6 illustrates an example computer system in which or with which the embodiments of the present disclosure may be implemented.

The foregoing shall be more apparent from the following more detailed description of the disclosure.

### LIST OF REFERENCE NUMERALS

100—Network Architecture
102-1, 102-2 . . . 102-N—Users
104-1, 104-2 . . . 104-N—User Equipments
108—System
202—Server
204—Memory
206—A Plurality of Interfaces
208—Processing Unit
210—Database
212—Data Parameter Engine
610—External Storage Device
620—Bus
630—Main Memory
640—Read Only Memory
650—Mass Storage Device
660—Communication Port
670—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

At present, when planning a wireless network, there are several coverage challenges that need to be considered. To plan a wireless network, a lot of considerations and methods such as site survey, user requirements, capacity planning, and frequency planning are performed and considered. To date, in a wireless communication system, a mobile station has been performing communication with a base station that forms a cell in which the mobile station exists. The mobile station changes a base station to another base station while moving in accordance with the position thereof. However, at the time of design and displacement of a base station, depending on transmission power and direction of an antenna, there may arise an area (hereinafter referred to as a “coverage hole”) in which communication quality of any base station does not reach a value that is allowed to communicate with the mobile station. In order to detect a coverage hole or to provide a continuous network coverage, a designer of a base station divides an area into a plurality of grids (sub-areas) and sets up one evaluation point in each of these grids. Next, the designer measures communication qualities of neighbouring base stations at each of the evaluation points. Multiple iterations are required with varying inputs to arrive at the best wireless network. This traditional approach is manual, tedious, and poses several challenges. The general base grids show the network capabilities but fail to address the issues faced by each individual in a particular grid. Hence, a system and a method are required to address the aforementioned issue.

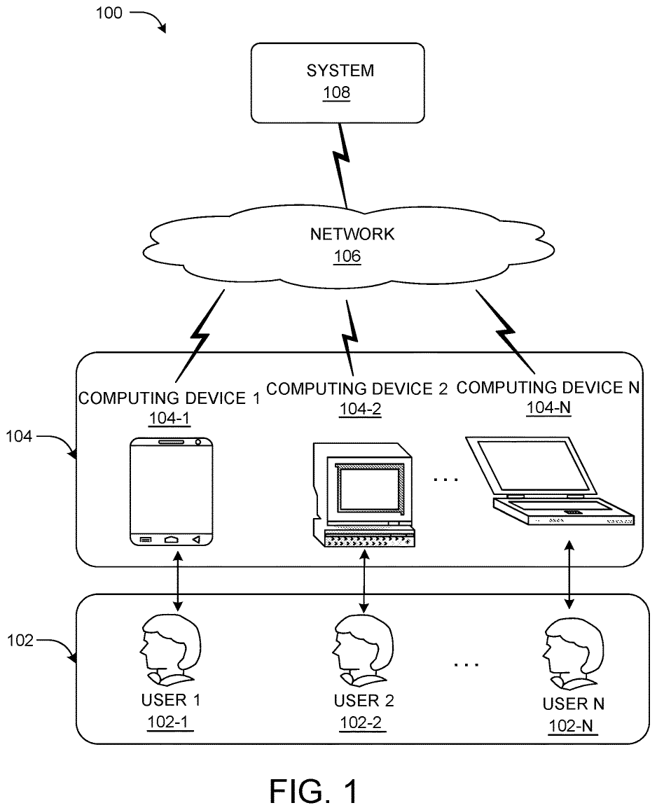

The various embodiments throughout the disclosure will be explained in more detail with reference to FIG. 1-FIG. 6.

FIG. 1 illustrates an example network architecture (100) for implementing a system for detecting recurrence of coverage holes in a network by analysing coverage hole polygons (hereinafter interchangeably referred to as “the system 108”), in accordance with an embodiment of the present disclosure.

As illustrated in FIG. 1, one or more computing devices (104-1, 104-2 . . . 104-N) are connected to the system (108) through a network (106). A person of ordinary skill in the art will understand that the one or more computing devices (104-1, 104-2 . . . 104-N) are collectively referred as computing devices (104) and individually referred as a computing device (104). One or more users (102-1, 102-2 . . . 102-N) provide one or more requests to the system (108). A person of ordinary skill in the art will understand that the one or more users (102-1, 102-2 . . . 102-N) are collectively referred as users (102) and individually referred as a user (102). Further, the computing devices (104) may also be referred as a user equipment (UE) (104) or as UEs (104) throughout the disclosure.

In an embodiment, the computing device (104) includes, but not be limited to, a mobile, a laptop, etc. Further, the computing device (104) includes one or more in-built or externally coupled accessories including, but not limited to, a visual aid device such as a camera, audio aid, microphone, or keyboard. Furthermore, the computing device (104) includes a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) is configured to receive an input (a plurality of data samples) from the one or more computing devices (104) associated with the one or more users (102). The system (108) is configured to receive the plurality of data samples from a plurality of user equipments residing in a predefined area. The plurality of data samples may include details such as network traffic patterns, packet headers, throughput rates, latency measurements, error rates, device configurations, routing tables, Quality of Service (QoS) parameters, network topology maps, security logs, and performance metrics like uptime and downtime. Analyzing these data samples, the system enables network administrators and engineers to identify bottlenecks, security threats, performance issues, and optimize network efficiency and reliability. The system (108) is configured to generate a value corresponding to at least one RF parameter corresponding to the plurality of user equipments. The system (108) is configured to aggregate the received plurality of data samples to generate a plurality of new coverage hole polygons. In an example, the plurality of user equipments is an indoor user equipment, and an outdoor user equipments. In an embodiment, the at least one RF parameters includes reference signal received power (RSRP), reference signal received quality (RSRQ), received signal strength indicator (RSSI), signal to interference noise ratio (SINR), channel quality index (CQI), physical cell identity (PCI), block error ratio (BLER), downlink throughput, and uplink throughput.

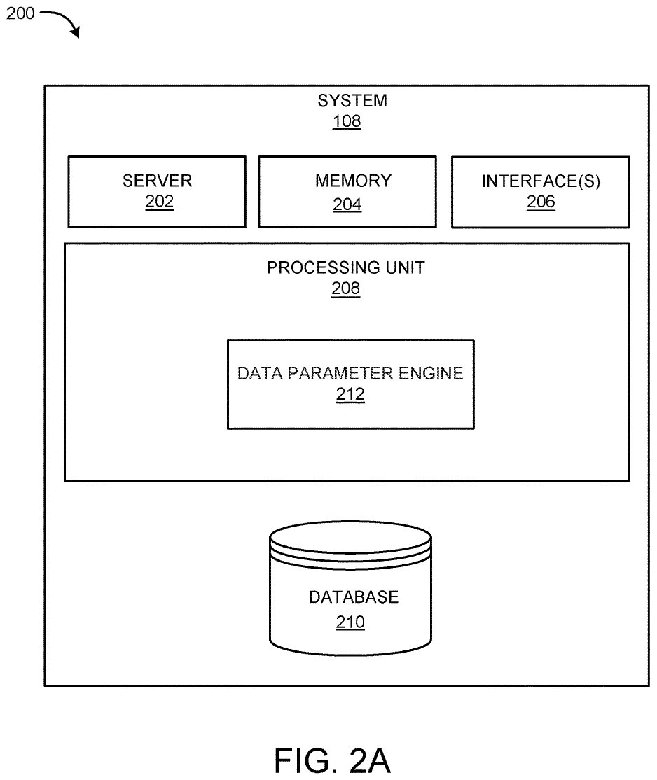

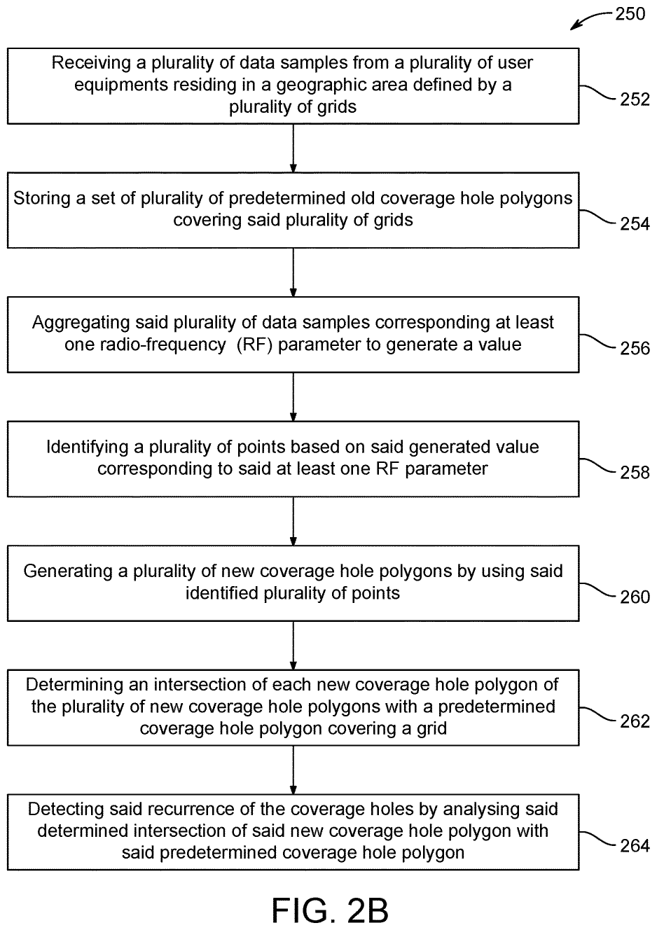

FIG. 2A illustrates an example block diagram (200) of the system (108), in accordance with an embodiment of the present disclosure.

Referring to FIG. 2A, in an embodiment, the system (108) includes a server (202) and a processing unit (208).

The server is configured to receive a plurality of data samples from a plurality of user equipments residing in a geographic area. In an embodiment, the plurality of user equipments includes an indoor user equipment, and an outdoor user equipment. The geographic area is defined by a plurality of grids. In an aspect, the server is configured to store the received plurality of data samples in a database. In an aspect, the server is configured to store the plurality of data samples for a predetermined day. In an example, the predetermined days is 7-15 days. The server is further configured to store a set of plurality of predetermined old coverage hole polygons covering the plurality of grids. In an aspect, the system is configured to perform a number of iterations to generate the plurality of coverage hole polygons indicating the coverage holes. In an example, the server is configured to store the plurality of generated coverage hole polygons. In another example, the plurality of generated coverage hole polygons generated during a current iteration may act as a plurality of old coverage hole polygons for a next iteration.

The processing unit is configured to cooperate with the server to receive the plurality of data samples. The processing unit is further configured to aggregate the plurality of data samples corresponding to at least one radio-frequency (RF) parameter to generate a value. In an embodiment, the at least one RF parameter includes reference signal received power (RSRP), reference signal received quality (RSRQ), received signal strength indicator (RSSI), signal to interference noise ratio (SINR), channel quality index (CQI), physical cell identity (PCI), block error ratio (BLER), downlink throughput, and uplink throughput. In an example, the processing unit is configured to extract a number of data samples from the plurality of data samples. Further, the processing unit is configured to aggregate the extracted data samples corresponding to a particular RF parameter and generated an aggregated value. For example, the processing unit is configured to aggregate the extracted data samples corresponding to RSRQ parameter and generated the aggregated value corresponding to the RSRQ. In an aspect, the processing unit is configured to store the generated aggregated value corresponding to each RF parameter in the database. The processing unit is configured to identify a plurality of points based on the generated value corresponding to the at least one radio-frequency (RF) parameter. In an aspect, the processing unit is configured to identify the plurality of points by comparing the generated values with a threshold value predefined corresponding to the at least one RF parameter in the database. If the generated value is less than the predefined threshold value, then the point is considered as a point where network coverage is zero or negligible. The processing unit is configured to generate a plurality of new coverage hole polygons by using the plurality of identified points. During each iteration, the processing unit is configured to determine an intersection of each of new coverage hole polygon with a predetermined old coverage hole polygon covering a particular grid. The processing unit is configured to detect recurrence of the coverage holes by analysing the determined intersection of the new coverage hole polygon with the predetermined coverage hole polygon. If there is an intersection between the new coverage hole polygon and the predetermined coverage hole polygon, the processing unit detects that the coverage hole is still there and if there is less or no intersection, then the processing unit detects that the there is an improvement in the network coverage or there may be a temporary coverage issues as identified by the new coverage hole polygons.

In an embodiment, the processing unit is further configured to calculate an overlapping area between the new coverage hole polygon and the predetermined old coverage hole polygon. The overlapping area is calculated by finding an area of intersection between the new coverage hole polygon and the predetermined old coverage hole polygon. Based on the determined overlapping area, the processing unit is configured to assign a unique ID (unique identifier) to each of the plurality of new coverage hole polygons. The unique ID is assigned to a specific entity (coverage hole polygons) in a database. The unique ID is used to distinguish one entity from another and to ensure that each entity has a unique identifier. Unique IDs can be generated using various methods, such as hashing algorithms or random number generators. The processing unit is further configured to assign an old parent ID corresponding to the predetermined old coverage hole polygon to the new coverage hole polygon if the overlapping area is greater than or equal to a predetermined value. In an embodiment, the predetermined value is 70%. The ID assigned to the old coverage hole polygon is known as the parent ID, and the ID assigned to the new coverage hole polygon is known as the child ID. If a coverage-challenged area is split during the next generation cycle, the original area is marked as a parent polygon (old coverage hole polygon), and the split area is marked as a child polygon (new coverage hole polygon). The process of generating polygon IDs for parent-child relationships involves assigning unique identifiers to polygons that are part of a hierarchical structure. This is typically used in geographic information systems (GIS) where polygons represent geographical areas, such as countries, states, and cities. The parent-child relationship refers to the way in which these polygons are organized. The generation of IDs for these polygons is important for managing and analyzing spatial data.

The processing unit is further configured to assign a new child ID to the new coverage hole polygon if the overlapping area is less than the predetermined value. In an embodiment, the processing unit is configured to assign a new parent ID to the new coverage hole polygon if the new coverage hole polygon does not intersect with the predetermined old coverage hole polygon or the overlapping area between the new coverage hole polygon and the predetermined old coverage hole polygon is less than 30%.

In an embodiment, the system (processing unit) is configured to generate the new coverage hole polygon by converting each of the plurality of identified points into the polar coordinates. After converting the identified points into the polar coordinates, processing unit is configured to sort the plurality of polar coordinates either in a counterclockwise direction or a clockwise direction based on an angle with respect to a centroid to generate an array of sorted polar coordinates. The processing unit is configured to take a first polar coordinate (or a first point corresponding to the first polar coordinate) from the sorted polar coordinates as a starting polar coordinate. After choosing the starting polar coordinate, the processing unit is configured to choose a second polar coordinate from the array of sorted polar coordinates. In an embodiment, the second polar coordinate is the right most coordinate from the array of sorted polar coordinates with respect to the first polar coordinate.

The processing unit is configured to determine a distance between the second polar coordinate and the first polar coordinate. The processing unit is configured to connect the second polar coordinate to the new coverage hole polygon if the determined distance is lesser than a predefined distance. In an example, the predefined distance is 150 meters. In an aspect, the processing unit is further configured to choose a new polar coordinate lies before to the second polar coordinate if the determined distance is greater than the predefined distance and considers the new chosen polar coordinate as the second polar coordinate. The processing unit is configured to remove the connected first polar coordinate and second polar coordinate from the array of sorted polar coordinates.

The processing unit (208) is implemented as one or more microprocessors, microcomputers, microcontrollers, digital signal processors, central processing units, logic circuitries, and/or any devices that process data based on operational instructions. Among other capabilities, the processing unit (208) is configured to fetch and execute computer-readable instructions stored in a memory (204) of the system (108). The memory (204) is configured to store one or more computer-readable instructions or routines in a non-transitory computer readable storage medium, which is fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) includes an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, a database (210). Further, the processing unit (208) may include a data parameter engine (212) and other engine(s). In an embodiment, the other engine(s) may include, but not limited to, a data ingestion engine, an input/output engine, and a notification engine.

In an embodiment, the processing unit (208) is implemented as a combination of hardware and programming (for example, programmable instructions) to implement one or more functionalities of the processing unit (208). In examples described herein, such combinations of hardware and programming is implemented in several different ways. For example, the programming for the processing unit (208) is processor-executable instructions stored on a non-transitory machine-readable storage medium and the hardware for the processing unit (208) may comprise a processing resource (for example, one or more processors), to execute such instructions. In the present examples, the machine-readable storage medium may store instructions that, when executed by the processing resource, implement the processing unit (208). In such examples, the system (108) may comprise the machine-readable storage medium storing the instructions and the processing resource to execute the instructions, or the machine-readable storage medium is separate but accessible to the system (108) and the processing resource. In other examples, the processing unit (208) is implemented by electronic circuitry.

In an embodiment, the system is configured to display the generated plurality of new coverage hole polygons and the intersection between the new coverage hole polygon and the predetermined old coverage hole polygons on a mapping application. In an aspect, the mapping application is a Web Browser (e.g., INTERNET EXPLORER manufactured by Microsoft Corp. of Redmond, Wash., or SAFARI, manufactured by Apple Computer of Cupertino, Calif.). In some examples, the mapping application may be a software or a mobile application from an application distribution platform. Examples of application distribution platforms include the App Store for iOS provided by Apple, Inc., Play Store for Android OS provided by Google Inc., and such application distribution platforms. In an aspect, the mapping application may be embedded with the user device. The user device may include a processor, a display, a memory, a battery, and an input-means such as a hard keypad and/or a soft keypad. The user device may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user device may include, but not limited to, a mobile phone, smartphone, virtual reality (VR) devices, augmented reality (AR) devices, laptop, a general-purpose computer, desktop, personal digital assistant, tablet computer, mainframe computer, or any other device.

In an embodiment, the processing unit (208) receives the input (plurality of data samples) from the server via the data parameter engine (212). The input is received from the one or more computing devices (104) associated with the one or more users (104). The processing unit (208) stores the input in the database (210).

In an embodiment, the processing unit (208) determines a coverage hole. The coverage hole includes an area or zone within the network (106) where the signal strength or quality is significantly lower or completely absent. Further, the processing unit (208) determines one or more points associated with the coverage hole.

In an embodiment, as an example, the geographic area includes N×N grids where one grid further includes one or more cells. Further in an embodiment, the processing unit (208) is configured to visualize one or more polygon boundaries associated with the data received from the server and the one or more points within the geographic area. The processing unit (208) is configured to use one or technique to visualize the one or more polygon boundaries.

In an embodiment, the processing unit (208) is configured to bifurcate the one or more polygon boundaries into a parent polygon and a child polygon based on an area of intersection between the parent polygon and the child polygon.

In an aspect, the system (108) is configured to display the generated plurality of new coverage hole polygons and the intersection between the new coverage hole polygon and the predefined polygon on a displaying screen such that a user can easily analyse the data.

In an embodiment, the system (108) is configured to bifurcate the one or more polygon boundaries into a parent polygon and a child polygon based on an area of intersection between the parent polygon and the child polygon. If a coverage area is spilt in next coverage area generation cycle, the original coverage challenged area marked as Parent polygon and split area as child polygon. The system (108) is configured to check the consistency of coverage area. The system (108) is configured to determine the consistency of the coverage by determining the coverage holes present in the network. Consistency of coverage area refers to the reliability and uniformity of network coverage provided by the service providers. Consistency of coverage area implies that the service provider ensures that the area they claim to cover with their network or signal are able to maintain consistent quality and availability throughout that area. Consistent quality measures if the network is sufficient to support common mobile application requirements at a level that is ‘good enough’ for users to maintain (or complete) various typical tasks on their devices. In an aspect, to measure consistent quality a number of indicators such as download speed, upload speed, latency, jitter, packet discard, and time to first byte are considered. These indicators are evaluated against a threshold value respectively recommended by various more demanding common applications.

The system is configured with a capability to determine the consistency of coverage by identifying coverage gaps or holes within the network. The system ensures that the network provides adequate coverage to users without any significant dead zones (zone with zero network coverage) or areas lacking in signal strength. The system is configured to employs various techniques such as signal strength monitoring, network performance analysis, and possibly predictive modelling to identify areas where coverage is insufficient or inconsistent. Once these coverage holes are identified, network operators or administrators can take appropriate measures to address them, which may include deploying additional infrastructure such as antennas or repeaters, adjusting signal parameters, or optimizing network configuration. By continuously monitoring coverage consistency and addressing any identified gaps, the system can help ensure a reliable and seamless experience for users accessing the network.

In an embodiment, the processing unit (208) is configured to assign one or more polygon IDs to the parent polygon and the child polygon based on the area of intersection.

Although FIG. 2A shows exemplary components of the system (108), in other embodiments, the system (108) may include fewer components, different components, differently arranged components, or additional functional components than depicted in FIG. 2A. Additionally, or alternatively, one or more components of the system (108) may perform functions described as being performed by one or more other components of the system (108).

FIG. 2B illustrates steps of a method (250) of detecting a recurrence of coverage holes in the network by analysing coverage hole polygons, in accordance with an embodiment of the present disclosure.
Step (252) includes receiving a plurality of data samples from a plurality of user equipments residing in a geographic area defined by a plurality of grids. In an example, the plurality of user equipments is an indoor user equipment, and an outdoor user equipments.
Step (254) includes storing a set of plurality of predetermined old coverage hole polygons covering the plurality of grids.
Step (256) includes aggregating the plurality of data samples corresponding at least one radio-frequency (RF) parameter to generate a value. In an embodiment, the at least one RF parameters includes reference signal received power (RSRP), reference signal received quality (RSRQ), received signal strength indicator (RSSI), signal to interference noise ratio (SINR), channel quality index (CQI), physical cell identity (PCI), block error ratio (BLER), downlink throughput, and uplink throughput.
Step (258) includes identifying a plurality of points based on the generated value corresponding to the at least one RF parameter.
Step (260) includes generating a plurality of new coverage hole polygons by using the identified plurality of points.
Step (262) includes determining an intersection of each new coverage hole polygon of the plurality of new coverage hole polygons with a predetermined coverage hole polygon covering a grid.
Step (264) includes detecting the recurrence of the coverage holes by analysing the determined intersection of the new coverage hole polygon with the predetermined coverage hole polygon.

In an aspect, the method (250) further includes a step of detecting recurrence includes calculating an overlapping area between the new coverage hole polygon and the predetermined coverage hole polygon; and based on the calculated overlapping area assigning a unique ID to each of the plurality of new coverage hole polygons.

In an aspect, the method (250) further includes a step of assigning an old polygon ID corresponding to the predetermined coverage hole polygon to the new coverage hole polygon if the overlapping area is greater than or equal to a predetermined value.

In an aspect, the method (250) further includes a step of assigning a new child ID to the new coverage hole polygon if the overlapping area is less than the predetermined value. In an example, the predetermined value is 70%.

In an aspect, the method (250) further includes a step of assigning a new parent ID to the new coverage hole polygon if the new coverage hole polygon does not intersect with the predetermined polygon or area of the intersection between the new coverage hole polygon and the predetermined old coverage hole polygon is less than 30%.

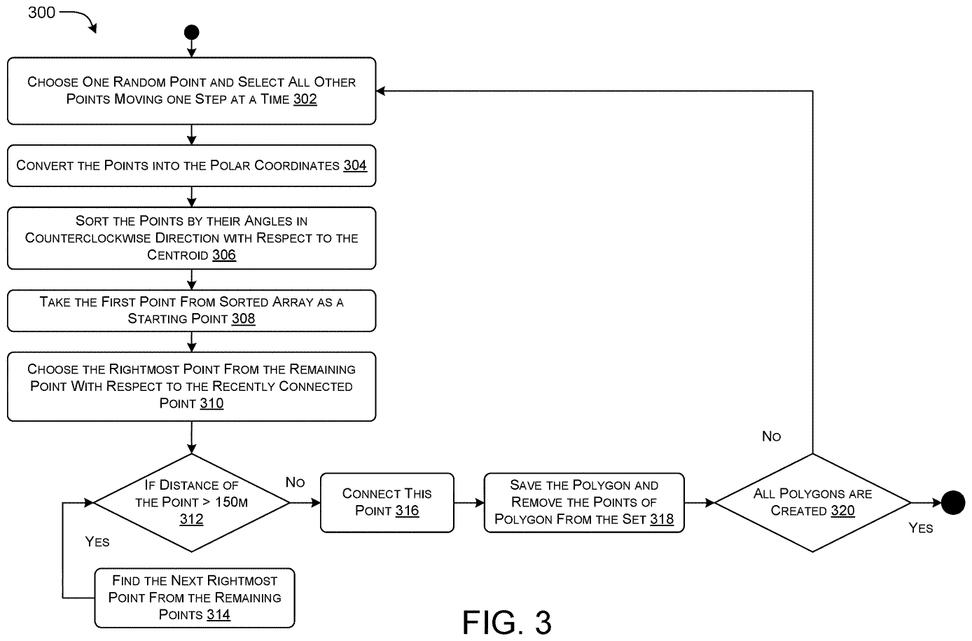

FIG. 3 illustrates an example flow diagram (300) for creating the plurality of coverage hole polygons, in accordance with an embodiment of the present disclosure.

As illustrated in FIG. 3, the following steps are implemented by the system (108).
At step 302: The system (108) chooses one random point and select all other points moving one step at a time. The method includes receiving a plurality of data samples from a plurality of user equipments residing in a geographic area defined by a plurality of grids. The method includes storing a set of plurality of predetermined old coverage hole polygons covering the plurality of grids. The method includes aggregating the plurality of data samples corresponding at least one radio-frequency (RF) parameter to generate a value. The method includes identifying a plurality of points based on the generated value corresponding to the at least one RF parameter.
At step 304, The system (108) converts each of the identified points into polar coordinates. Polar coordinates are a way of representing the position of the identified point in a two-dimensional plane using an angle and a distance from a fixed point, called the origin. The conversion involves calculating the distance between the point and the origin, as well as the angle between the positive x-axis and the line connecting the point and the origin. Once the system has these values, it can represent the point in polar form as (r, θ), where r is the distance and θ is the angle in radians. In an example, the identified points are the points that are facing coverage issues.
At step 306: The system (108) sorts the points (converted polar coordinates) by their angles either in a counterclockwise direction or in a clockwise direction with respect to a centroid to generate an array of sorted polar coordinates.
At step 308: The system (108) takes the first point (corresponding to the first polar coordinate) from the sorted array as a standing point (starting polar coordinate).
At step 310: The system (108) chooses a second polar coordinate from the array of sorted polar coordinates with respect to the first polar coordinate. In an aspect, the second polar coordinate is the right most point from the remaining points (array of sorted polar coordinates) with respect to the recently connected point.
At step 312: The system (108) determines a distance between the second polar coordinate and the first polar coordinate. The system (108) connects the second polar coordinate to the new coverage hole polygon if the determined distance is lesser than a predefined distance. The predefined distance is 150 meters.

If the distance of the point is greater than 150 meters, at step 314: Based on a positive determination from step 312, the system (108) finds the next rightmost point from the remaining points (array of sorted polar coordinates). The system (108) chooses a new polar coordinate lies before to the second polar coordinate if the determined distance is greater than the predefined distance and considering the new chosen polar coordinate as the second polar coordinate.
At step 316: Based on a negative determination from step 312, the system (108) connects this point.
At step 318: The system (108) saves the polygon and removes the points of polygon (connected first polar coordinate and second polar coordinate) from the array of polar coordinates.
At step 320: The system (108) determines if all the polygons are created covering all the points. Based on a positive determination from this step the system (108) terminates the process. Based on a negative determination from this step, the system (108) is configured to continue with step 302.

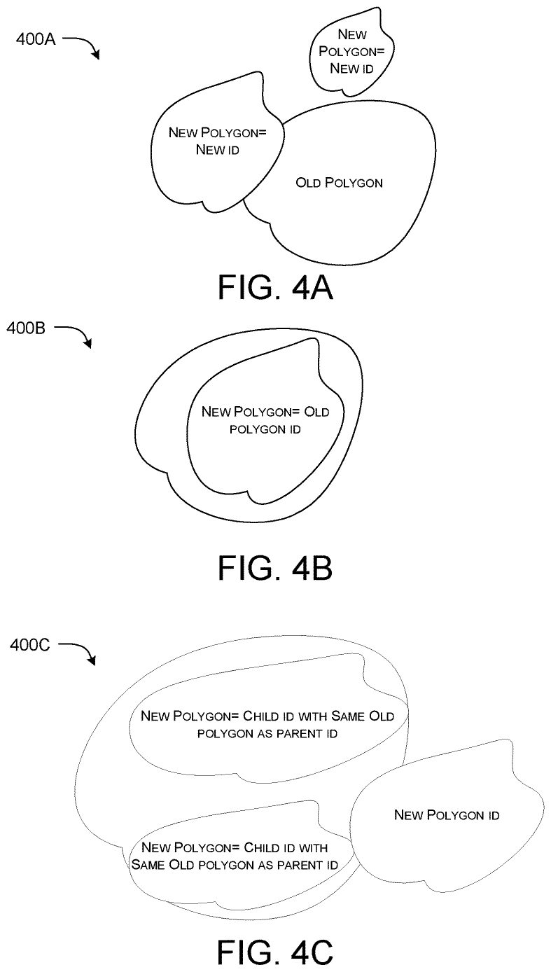

FIGS. 4A-4C illustrate various exemplary representations (400A, 400B, 400C) of parent-child polygon generation, in accordance with embodiments of the present disclosure.

As illustrated in FIGS. 4A-4C, the system (108) is configured to generate parent-child polygon ID's. The coverage area/predefined grid is bifurcated/split into a next coverage challenged area generation cycle. Further, the original coverage challenged area is marked as the parent polygon and the split area is marked as the child polygon.

As illustrated in FIG. 4A, in an embodiment, during a new cycle (iteration) if the generated new coverage hole polygon doesn't intersect with an old polygon or if an area of intersect less than 30 percent, the generated polygon is assigned a new parent polygon ID.

As illustrated in FIG. 4B, in an embodiment, if a new coverage hole polygon intersects with the old polygon and its area 70 percent or more than the old polygon area, the old parent id is assigned to the new coverage hole polygon.

As illustrated in FIG. 4C, in an embodiment, if the new coverage hole polygon intersects with the old polygon and the new coverage hole polygon area is 70 percent where more area lies in the old polygon area (but less than 70 percent of area of old polygon), the old parent ID is retained, and the new coverage hole polygon is assigned with a child ID.

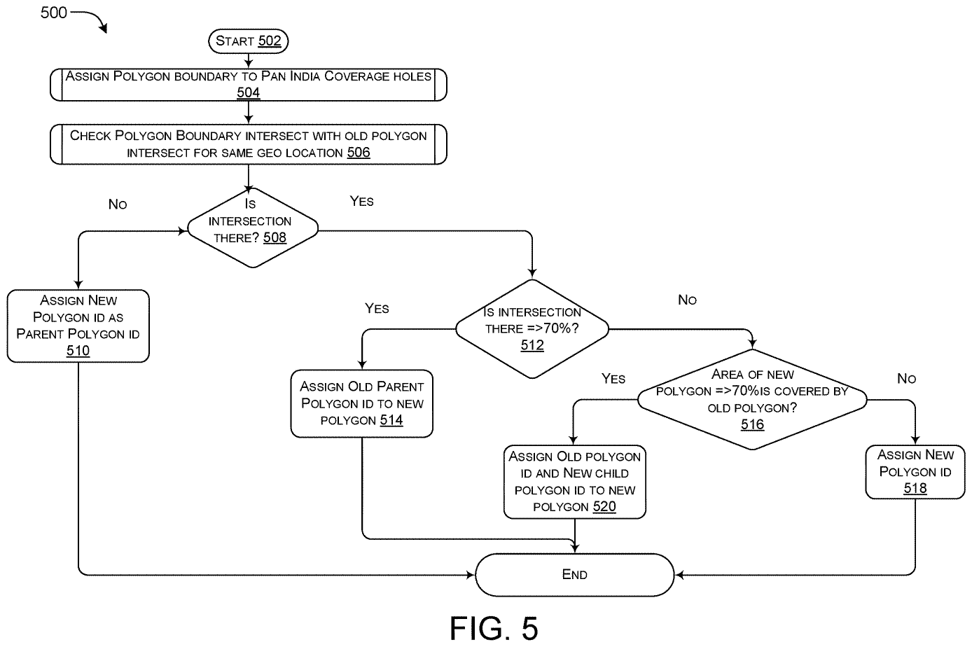

FIG. 5 illustrates an example flow diagram (500) of assigning polygon ID to a new coverage hole polygon based on parent-child identification (ID) relationship, in accordance with an embodiment of the present disclosure.

As illustrated in FIG. 5, the following steps are implemented by the system (108).
At step 502: The system (108) starts/initiates the process of parent-child identification logic. In this step the system (108) generated the plurality of new coverage hole polygons.
At step 504: The system (108) assigns a polygon boundary to the plurality of coverage holes. In an example, the system (108) assigns the polygon boundary across a whole country.
At step 506: The system (108) checks the polygon boundary of the new coverage hole polygon intersects with the old polygon for the same geographical location.
At step 508: The system (108) determines if an intersection exists.
At step 510: Based on a negative determination from step 508, the system (108) assigns a new polygon ID as the parent polygon ID and terminate the process.
At step 512: Based on a positive determination from step 508, the system (108) furthers determine if the intersection exists and the intersection is greater than or equal to 70 percent.
At step 514: Based on a positive determination from step 512, the system (108) assigns the old polygon ID to the new coverage hole polygon.
At step 516: Based on a negative determination from step 514, the system (108) determines if overlapping area of the new coverage hole polygon is greater than or equal to 70 percent and if this area is covered by the old polygon.
At step 518: Based on a negative determination from step 516, the system (108) assigns the new polygon ID and terminates the process.
At step 520: Based on a positive determination from step 516, the system (108) assigns an old polygon ID and a new child polygon ID to the new coverage hole polygon.

In an exemplary embodiment, the present disclosure discloses a user equipment which is configured to detect a plurality of coverage holes in a network. The user equipment includes a processor, and a computer readable storage medium storing programming instructions for execution by the processor. Under the programming instructions, the processor is configured to receive a plurality of data samples from a plurality of user equipments residing in a geographic area defined by a plurality of grids. Under the programming instructions, the processor is configured to store a set of plurality of predetermined old coverage hole polygons covering the plurality of grids. Under the programming instructions, the processor is configured to aggregate the plurality of data samples corresponding at least one radio-frequency (RF) parameter to generate a value. Under the programming instructions, the processor is configured to identify a plurality of points based on the generated value corresponding to each RF parameter. Under the programming instructions, the processor is configured to generate a plurality of new coverage hole polygons by using the plurality of identified points. Under the programming instructions, the processor is configured to determine an intersection of each of new coverage hole polygon with a predetermined old coverage hole polygon covering a grid. Under the programming instructions, the processor is configured to detect recurrence of the coverage holes by analysing the determined intersection of the new coverage hole polygon with the predetermined coverage hole polygon.

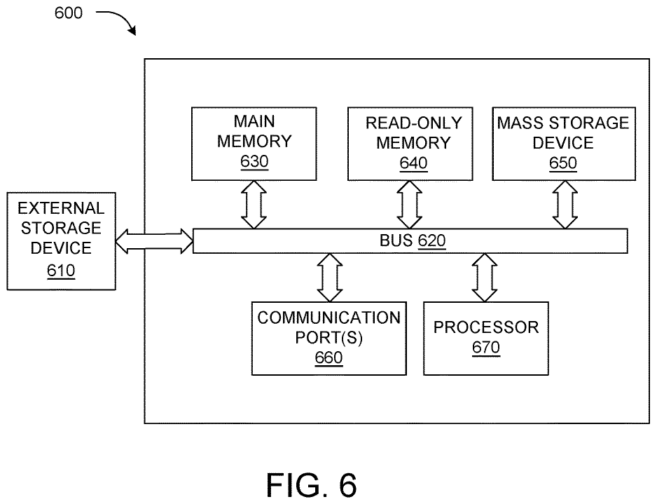

FIG. 6 illustrates an example computer system (600) in which or with which the embodiment of the present disclosure is implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) is any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) is chosen depending on a network, such as a Local Area Network (LAN), Wide Area Network (WAN), or any network to which the computer system (600) connects.

In an embodiment, the main memory (630) is Random Access Memory (RAM), or any other dynamic storage device commonly known in the art. The read-only memory (640) is any static storage device(s) e.g., but not limited to, a Programmable Read Only Memory (PROM) chip for storing static information e.g., start-up or basic input/output system (BIOS) instructions for the processor (670). The mass storage device (650) is any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) is, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (670) to the computer system (600).

In another embodiment, operator, and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

The present disclosure is configured to provide wireless network planning and design of 5G networks. The system (108) can be extended to other technologies as well such as Wi-Fi, and various areas where base grids are required. The system (108) is helpful for telecom operators to optimize their network coverage by identifying and addressing coverage holes, thereby ensuring a more reliable and consistent service for users. The system (108) can be employed in rural areas to identify and improve coverage, supporting communication and connectivity. For satellite communication systems, the detection of coverage holes is crucial to maintain global coverage and the system (108) employed in satellite communication ensures that there are no blind spots in the satellite network. Further, the system (108) may be used in industrial IoT where a connectivity can benefit from coverage hole detection to ensure uninterrupted data transmission, leading to improved operational efficiency and reduced downtime. It could aid in identifying areas with poor coverage, both indoors and outdoors, and help plan for network optimization.

The method and system (108) of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

### ADVANTAGES OF THE INVENTION

The present disclosure provides a system and a method that provides efficient utilization of resources.

The present disclosure provides a system and a method that provides better network planning as the system identifies patterns, trends in coverage holes, and develops strategies for improving network coverage.

The present disclosure provides a system and a method that improves network coverage and provides customer satisfaction.

The present disclosure provides a system and a method that increases revenue, profitability based on the efficient utilization of resources.

The present disclosure provides an early detection mechanism for identifying one or more problems in the network system.

The present disclosure dynamically provides flexible problem tracking and allows for adjustments with new incoming information.

1. A system for detecting a recurrence of coverage holes in a network by analysing coverage hole polygons, said system (108) comprising:
a server configured to receive a plurality of data samples from a plurality of user equipments residing in a geographic area defined by a plurality of grids, said server is further configured to store a set of plurality of predetermined old coverage hole polygons covering said plurality of grids; and
a processing unit configured to cooperate with said server to receive said plurality of data samples and is further configured to:
aggregate said plurality of data samples corresponding to at least one radio-frequency (RF) parameter to generate a value;
identify a plurality of points based on said generated value corresponding to said at least one RF parameter;
generate a plurality of new coverage hole polygons by using said identified plurality of points;
determine an intersection of each new coverage hole polygon of said plurality of new coverage hole polygons with a predetermined old coverage hole polygon covering a grid; and
detect said recurrence of the coverage holes by analysing said determined intersection of a new coverage hole polygon with said predetermined old coverage hole polygon.

2. The system as claimed in claim 1, wherein said processing unit is further configured to:
calculate an overlapping area between said new coverage hole polygon and said predetermined old coverage hole polygon; and
based on said calculated overlapping area, assigning a unique Identifier (ID) to each of said plurality of new coverage hole polygons.

3. The system as claimed in claim 2, wherein said processing unit is further configured to assign an old polygon ID corresponding to said predetermined old coverage hole polygon to said new coverage hole polygon if said overlapping area is greater than or equal to a predetermined value, wherein said predetermined value is 70%.

4. The system as claimed in claim 3, wherein said processing unit is further configured to assign a new child ID to said new coverage hole polygon if said overlapping area is less than said predetermined value.

5. (canceled)

6. The system as claimed in claim 2, wherein said processing unit is configured to assign a new parent ID to said new coverage hole polygon if said new coverage hole polygon does not intersect with said predetermined old coverage hole polygon, or said overlapping area between said new coverage hole polygon and said predetermined old coverage hole polygon is less than 30%.

7. The system as claimed in claim 1, wherein said processing unit is configured to generate said plurality of new coverage hole polygons by following steps:
converting each of said identified plurality of points into a plurality of polar coordinates;
sorting said plurality of polar coordinates either in a counterclockwise direction or in a clockwise direction based on an angle with respect to a centroid to generate an array of sorted polar coordinates;
taking a first polar coordinate from said array of sorted polar coordinates as a starting polar coordinate;
choosing a second polar coordinate from said array of sorted polar coordinates with respect to said first polar coordinate;
determining a distance between said second polar coordinate and said first polar coordinate;
connecting said second polar coordinate to said new coverage hole polygon if said determined distance is lesser than a predefined distance; and
removing said first polar coordinate and said second polar coordinate from said array of sorted polar coordinates.

8. The system as claimed in claim 7, wherein said processing unit is further configured to choose a new polar coordinate lies before to said second polar coordinate if said determined distance is greater than said predefined distance and considers said new chosen polar coordinate as said second polar coordinate.

9. The system as claimed in claim 1, wherein said at least one RF parameter includes reference signal received power (RSRP), reference signal received quality (RSRQ), received signal strength indicator (RSSI), signal to interference noise ratio (SINR), channel quality index (CQI), physical cell identity (PCI), block error ratio (BLER), downlink throughput, and uplink throughput.

10. (canceled)

11. The system (108) as claimed in claim 7, wherein said second polar coordinate is a right most coordinate from said array of sorted polar coordinates with respect to said first polar coordinate.

12. The system as claimed in claim 1, is configured to display said generated plurality of new coverage hole polygons and said intersection between said new coverage hole polygon and said predetermined old coverage hole polygon on a mapping application.

13. (canceled)

14. A method of detecting a recurrence of coverage holes in a network by analysing coverage hole polygons, said method comprising:
receiving a plurality of data samples from a plurality of user equipments residing in a geographic area defined by a plurality of grids;
storing a set of plurality of predetermined old coverage hole polygons covering said plurality of grids;
aggregating said plurality of data samples corresponding to at least one radio-frequency (RF) parameter to generate a value;
identifying a plurality of points based on said generated value corresponding to said at least one RF parameter;
generating a plurality of new coverage hole polygons by using said identified plurality of points;
determining an intersection of each new coverage hole polygon of said plurality of new coverage hole polygons with a predetermined old coverage hole polygon covering a grid; and
detecting said recurrence of the coverage holes by analysing said determined intersection of a new coverage hole polygon with said predetermined old coverage hole polygon.

15. The method as claimed in claim 14, wherein said step of detecting said recurrence includes:
calculating an overlapping area between said new coverage hole polygon and said predetermined old coverage hole polygon; and
based on said calculated overlapping area, assigning a unique Identifier (ID) to each of said plurality of new coverage hole polygons.

16. The method as claimed in claim 15, further comprising assigning an old polygon ID corresponding to said predetermined old coverage hole polygon to said new coverage hole polygon if said overlapping area is greater than or equal to a predetermined value, wherein said predetermined value is 70%.

17. The method as claimed in claim 16, further comprising assigning a new child ID to said new coverage hole polygon if said overlapping area is less than said predetermined value.

18. (canceled)

19. The method as claimed in claim 15, further comprising assigning a new parent ID to said new coverage hole polygon if said new coverage hole polygon does not intersect with said predetermined old coverage hole polygon, or said overlapping area between said new coverage hole polygon and said predetermined old coverage hole polygon is less than 30%.

20. The method as claimed in claim 14, wherein said step of generating said plurality of new coverage hole polygons further includes steps of:
converting each of said identified number of points into a plurality of polar coordinates;
sorting said plurality polar coordinates either in a counterclockwise direction or a clockwise direction based on an angle with respect to a centroid to generate an array of sorted polar coordinates;
taking a first polar coordinate from said array of sorted polar coordinates as a starting polar coordinate;
choosing a second polar coordinate from said array of sorted polar coordinates with respect to said first polar coordinate;
determining a distance between said second polar coordinate and said first polar coordinate;
connecting said second polar coordinate to said new coverage hole polygon if said determined distance is lesser than a predefined distance; and
removing said first polar coordinate and said second polar coordinate from said array of sorted polar coordinates.

21. The method as claimed in claim 20, further includes a step of choosing a new polar coordinate lies before to said second polar coordinate if said determined distance is greater than said predefined distance and considering said new chosen polar coordinate as said second polar coordinate.

22. The method as claimed in claim 14, wherein said at least one RF parameter includes reference signal received power (RSRP), reference signal received quality (RSRQ), received signal strength indicator (RSSI), signal to interference noise ratio (SINR), channel quality index (CQI), physical cell identity (PCI), block error ratio (BLER), downlink throughput, and uplink throughput.

23. (canceled)

24. The method as claimed in claim 14, further includes a step of displaying said plurality of new coverage hole polygons and said intersection between said new coverage hole polygon and said predetermined old coverage hole polygon on a mapping application.

25. (canceled)

26. A computer program product comprising a non-transitory computer-readable medium comprising instructions that, when executed by one or more processors, cause the one or more processors to:
receive a plurality of data samples from a plurality of user equipments residing in a geographic area defined by a plurality of grids;
store a set of plurality of predetermined old coverage hole polygons covering said plurality of grids;
aggregate said plurality of data samples corresponding to at least one radio-frequency (RF) parameter to generate a value;
identify a plurality of points based on said generated value corresponding to said at least one RF parameter;
generate a plurality of new coverage hole polygons by using said identified plurality of points;
determine an intersection of each new coverage hole polygon of said plurality of new coverage hole polygons with a predetermined old coverage hole polygon covering a grid; and
detect a recurrence of coverage holes by analysing said determined intersection of a new coverage hole polygon with said predetermined old coverage hole polygon.
